(19) United States
(12) Patent Application Publication
(10) Pub. No.: US 2006/0132976 A1
(43) Pub. Date: Jun. 22, 2006

(54) Data recording disk and hard disk drive having the same

(75) Inventors: Sang-hyub Lee, Suwon-si (KR); Jong-hak Lee, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/290,798

(22) Filed: Dec. 1, 2005

(30) Foreign Application Priority Data
Dec. 18, 2004 (KR) 10-2004-0108402

(51) Int. Cl. G11B 5/82

(52) U.S. Cl. 360/135

(57) ABSTRACT

A data recording disk, and a hard disk drive provided with the data recording disk, the data recording disk including a clamping zone and a data zone, wherein at least a portion of a surface of the clamping zone varies in height from a surface of the data zone.

### CROSS-REFERENCE TO RELATED APPLICATIONS

This application claims the benefit of Korean Patent Application No. 10-2004-0108402, filed on Dec. 18, 2004, in the Korean Intellectual Property Office, the disclosure of which is incorporated herein by reference.

### BACKGROUND OF THE INVENTION

1. Field of the Invention

The present invention relates to a data recording disk, and, more particularly, to a data recording disk which is prevented from slipping by increasing a frictional force between the disk and a clamp, and a hard disk drive provided with the data recording disk.

2. Description of the Related Art

Hard disk drives (HDDs), which store information in devices such as computers, reproduce data stored in a recording medium such as a disk (and referred to as a disk hereinafter), and record data on the disk using a read/write head. In the HDDs, the disk is rotatably mounted on a spindle motor, and the head functions by being moved to a desired position by an actuator while being lifted above a recording surface of the disk at a predetermined height.

FIG. 1 is a perspective view illustrating a conventional data recording disk mounted on a spindle motor of an HDD.

Referring to FIG. 1, the HDD includes at least one disk 20, and a spindle motor 30 rotating the disk 20. The disk 20 is fitted around a hub 32 of the spindle motor 30. If two or more disks 20 are mounted on the spindle motor 30, a ring-shaped spacer 34 is disposed between the disks 20 to maintain a constant distance between the disks 20. The spacer 34 is fitted around the hub 32 of the spindle motor 30 so as to rotate together with the disks 20. A clamp 36 is coupled to an upper end of the hub 32 of the spindle motor 30 by an adhesion device such as coupling screws 38 to prevent separation of the disks 20. The disks 20 are firmly fixed to the hub 32 of the spindle motor 30 by the clamp 36 and the spacer 34.

A central hole 22, into which the hub 32 of the spindle motor 30 is inserted, is formed on the disk 20. A clamping zone 24 is formed around the central hole 22. The clamping zone 24 is in contact with the clamp 36 and/or the spacer 34. A force to fix the disk 20 to the hub 32 is applied to the clamping zone 24. A data zone 26, in which data is recorded, is formed outside the clamping zone 24.

As the data storage capacity of the disk 20 increases due to the remarkable advances in data storage technology, a distance between a surface of the disk 20 and a read/write head steadily decreases. Also, a surface roughness of the disk 20 is improved to help prevent defects on the surface of the disk 20. Accordingly, a contact force between the disk 20 and the clamp 36 and/or the spacer 34 decreases. If an external shock is applied to the HDD, a possibility that the disk 20 will slip increases. If such disk slip occurs, the disk 20 is deviated from the center, and accordingly the track following or switching performance of the read/write head is deteriorated. In particular, as the data storage capacity of the disk 20 increases, the number of tracks per inch (TPI) increases, and the width of tracks is reduced. As a result, there is an urgent demand to prevent the disk 20 from slipping.

To prevent the disk 20 from slipping due to an event such as a shock, a surface roughness of the clamping zone 24 of the disk 20, or a clamping force, should increase. However, it is very difficult to make the surface roughness of such a narrow area as the clamping zone 24 different from that of the data zone 26. Further, if the clamping force increases, the disk 20 may be distorted. Particularly, a small disk with a diameter of less than 1 inch has a thickness less than that of a relatively large disk with a diameter of, for example, 2.5 to 3.5 inches. If the clamping force increases, disk distortion may happen more easily. Accordingly, since the small disk is designed to have a clamping force smaller than that of the large disk, the small disk may suffer disk slip more often.

### SUMMARY OF THE INVENTION

The present invention provides a data recording disk which is prevented from slipping by increasing a frictional force between the disk and a clamp, and a hard disk drive having the provided with the data recording disk.

Additional aspects and/or advantages of the invention will be set forth in part in the description which follows and, in part, will be apparent from the description, or may be learned by practice of the invention.

According to an aspect of the present invention, there is provided a data recording disk comprising: a central hole; an annular clamping zone formed around the central hole; and a data zone formed outside the clamping zone, wherein the clamping zone has a plurality of protrusions.

The disk may further comprise a parking zone formed between the clamping zone and the data zone.

The plurality of protrusions may be formed by laser processing so as to have a crater shape.

According to another aspect of the present invention, there is provided a hard disk drive comprising: a spindle motor; at least one data recording disk mounted on the spindle motor; and an actuator moving a read/write head to a predetermined position over the data recording disk, wherein the data recording disk comprises: a central hole; an annular clamping zone formed around the central hole and having a plurality of protrusions; and a data zone formed outside the clamping zone.

According to another aspect of the present invention, there is provided a data recording disk comprising: a clamping zone; and a data zone; wherein at least a portion of a surface of the clamping zone varies in height from a surface of the data zone.

The portion of the surface of the clamping zone may be provided with one or more protrusions, recessed portions, ridges, or a combination thereof. The ridges may be provided in a radial direction of the disk.

Accordingly, a frictional force between the clamping zone of the disk and a clamp increases, thereby preventing disk slip due to a shock.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view illustrating a conventional data recording disk mounted on a spindle motor of a hard disk drive (HDD);

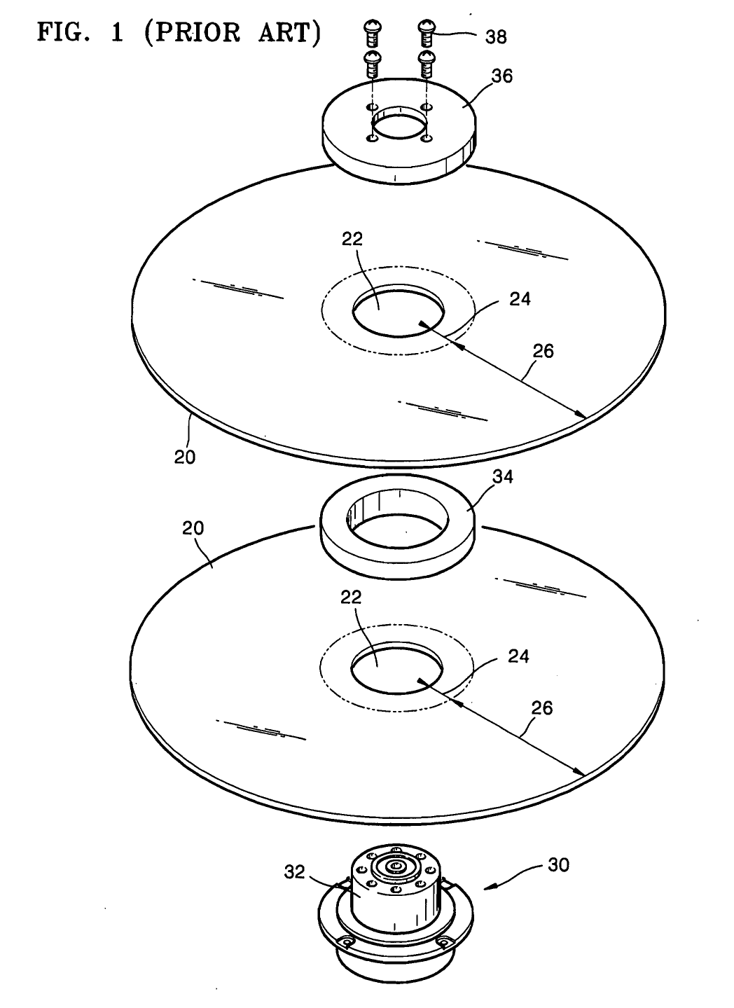

FIG. 2 is a perspective view illustrating an HDD provided with a data recording disk according to an embodiment of the present invention;

FIG. 3 is an exploded perspective view illustrating a spindle motor and a disk of the HDD shown in FIG. 2; and

FIG. 4 is a perspective view illustrating a data recording disk according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

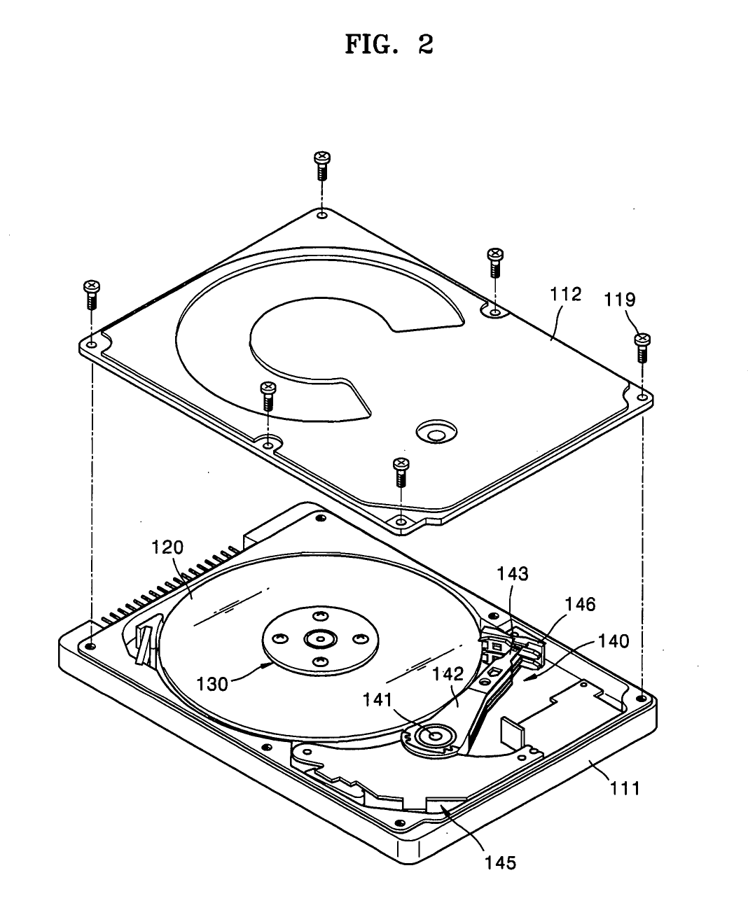

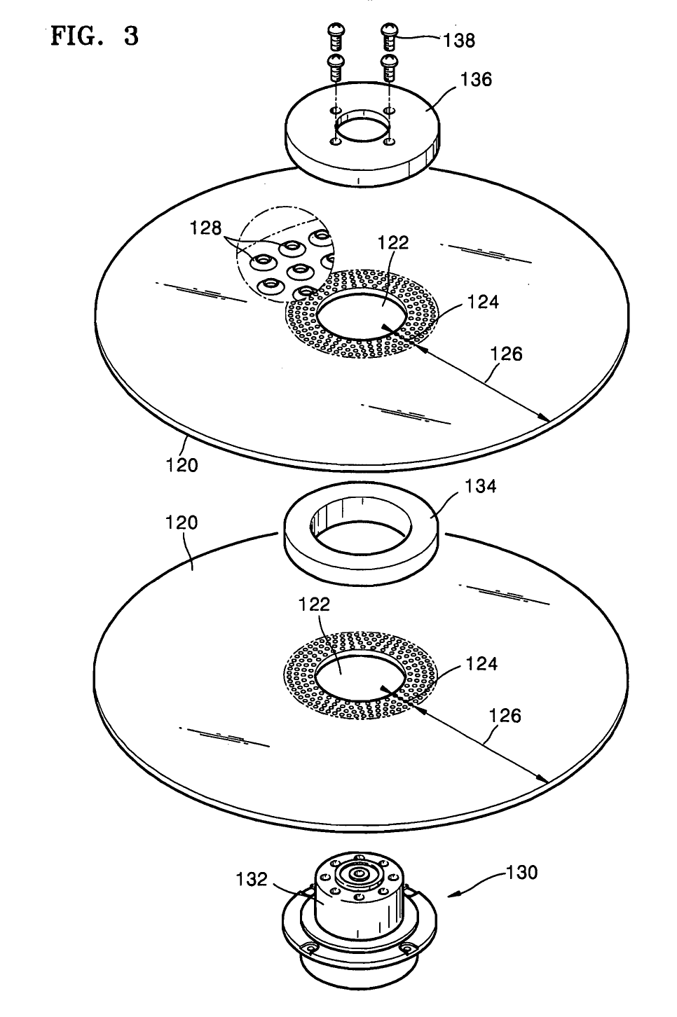

FIG. 2 is a perspective view illustrating a hard disk drive (HDD) provided with a data recording disk according to an embodiment of the present invention. FIG. 3 is an exploded perspective view illustrating a spindle motor and a disk of the HDD shown in FIG. 2.

Referring to FIGS. 2 and 3, the HDD includes a spindle motor 130, at least one data recording disk 120 mounted on the spindle motor 130, and an actuator 140 moving a read/write head (not shown) to reproduce and record data to a desired position on the disk 120.

The spindle motor 130 is provided on a base member 111 of the HDD. The spindle motor 130 has a hub 132 as a rotator. The data recording disk 120 is fitted around the hub 132. A coupling between the spindle motor 130 and the disk 120 will be explained later in detail.

The actuator 140 includes a swing arm 142 pivotably coupled to an actuator pivot 141 that is provided on the base member 111, a suspension 143 provided at one end of the swing arm 142 and elastically biasing a slider, on which the head is mounted, toward a surface of the disk 120, and a voice coil motor (VCM) 145 rotating the swing arm 142.

The VCM 145 is controlled by a servo control system, and rotates the swing arm 142 in a direction according to Fleming's Left Hand Rule due to an interaction between current input to a VCM coil and a magnetic field formed by a magnet.

Specifically, if the HDD is turned on and the disk 120 begins to rotate, the VCM 145 rotates the swing arm 142 counterclockwise to move the slider with the read/write head thereon over the disk 120.

In the meantime, if the HDD is turned off and the disk 120 stops rotating, the VCM 145 rotates the swing arm 142 clockwise to park the head on a ramp 146 disposed outside the disk 120. Such a head parking system is referred to as a ramp loading system.

The spindle motor 130, the disk 120, and the actuator 140 are covered and protected by a cover member 112. The cover member 112 is coupled to the base member 111 using fastening screws 119.

If two or more disks 120 are mounted on the spindle motor 130 as shown in FIG. 3, a ring-shaped spacer 134 is disposed between the disks 120 to maintain a constant distance between the disks 120. The spacer 134 is also fitted around the hub 132 of the spindle motor 130 so as to rotate together with the disks 120. A clamp 136 is coupled to an upper end of the hub 132 of the spindle motor 130 using coupling screws 138 to prevent separation of the disks 120. The disks 120 are firmly fixed to the hub 132 of the spindle motor 130 by the clamp 138 and/or the spacer 134.

A central hole 122, into which the hub 132 of the spindle motor 130 is inserted, is formed on the disk 120, and a clamping zone 124 is formed around the central hole 122. The clamping zone 124 is in contact with the clamp 136 and/or the spacer 134. A force to fix the disks 120 to the hub 132 using the clamp 136 is applied to the clamping zone 124. A data zone 126, in which data is recorded, is formed outside the clamping zone 124.

According to this embodiment of the present invention, a plurality of fine protrusions 128 are formed on the clamping zone 124 of the disk 120. The plurality of fine protrusions 128 may be formed in various ways. For example, they may be formed by laser processing. In this case, each of the plurality of protrusions 128 may have a crater shape as shown in FIG. 3. Although this embodiment describes protrusions 128 provided on the clamping zone 124 of the disk 120, the present invention is not limited to such. Other embodiments are possible to vary a height of the surface of the clamping zone 134 from the surface of the data zone 126, such as recesses, ridges, etc., or a combination thereof.

Due to the plurality of fine protrusions 128 formed on the clamping zone 124 of the disks 124, a frictional force between the clamping zone 124 and the clamp 136 and a frictional force between the clamping zone 124 and the spacer 134 increase. Consequently, the disks 120 can be more firmly fixed to the spindle motor 130, and even though an external shock is applied to the HDD, disk slip does not occur.

A contact start stop (CSS) system may be used as the head parking system rather than the ramp loading system shown in FIG. 2. In other words, while the disks 120 according to the present embodiment illustrated in FIGS. 2 and 3 are used in the HDD employing the ramp loading system, the disks 120 can be applied to an HDD employing the CSS system as well.

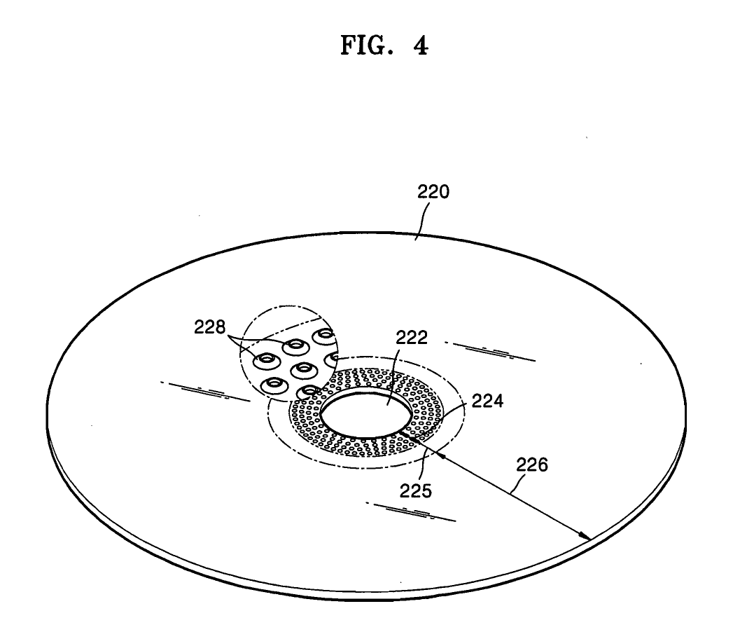

FIG. 4 is a perspective view of a data recording disk according to another embodiment of the present invention.

Referring to FIG. 4, in the CSS system, a parking zone 225 where data is not recorded is formed outside a clamping zone 224 of a disk 220. If the HDD stops operating, that is, if the disk 220 stops rotating, the slider on which the head is mounted is parked on the parking zone 225.

Accordingly, the disk 220 includes a central hole 222 into which the hub 132 of the spindle motor 130 is inserted, the annular clamping zone 224 formed around the central hole 222, a data zone 226, in which data is recorded, formed outside the clamping zone 224, and the parking zone 225 formed between the clamping zone 224 and the data zone 226 to allow the head to be parked thereon.

A plurality of fine protrusions 228 are formed on the clamping zone 224 of the disk 220. The plurality of fine protrusions 224 may be formed by laser processing to have a crater shape.

Since the operation and effect of the plurality of fine protrusions 228 are the same as those of the plurality of fine protrusions 128 illustrated in FIGS. 2 and 3, a detailed explanation thereof will not be given.

As described above, according to the present invention, a frictional force between the clamping zone of the disk and the clamp and/or the spacer is increased, thereby more effectively preventing disk slip due to an event such as a shock. Consequently, the performance deterioration of the read/write head due to the disk slip can be avoided, and a disk with a greater TPI can be more easily realized.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A data recording disk comprising:
a central hole;
an annular clamping zone formed around the central hole; and
a data zone formed outside the clamping zone,
wherein the clamping zone has a plurality of protrusions.

2. The disk of claim 1, further comprising a parking zone formed between the clamping zone and the data zone.

3. The disk of claim 1, wherein the plurality of protrusions are formed by laser processing.

4. The disk of claim 3, wherein one or more of the plurality of protrusions have a crater shape.

5. The disk of claim 1, wherein one or more of the plurality of protrusions have a crater shape.

6. A hard disk drive comprising:
a spindle motor;
at least one data recording disk mounted on the spindle motor; and
an actuator to move a read/write head to a predetermined position over the data recording disk;
wherein the data recording disk comprises:
a central hole,
an annular clamping zone formed around the central hole and having a plurality of protrusions, and
a data zone formed outside the clamping zone.

7. The hard disk drive of claim 6, wherein the data recording disk further comprises a parking zone formed between the clamping zone and the data zone.

8. The hard disk drive of claim 6, wherein the plurality of protrusions are formed by laser processing.

9. The hard disk drive of claim 8, wherein one or more of the plurality of protrusions have a crater shape.

10. The hard disk drive of claim 6, wherein one or more of the plurality of protrusions have a crater shape.

11. A data recording disk comprising:
a clamping zone; and
a data zone;
wherein at least a portion of a surface of the clamping zone varies in height from a surface of the data zone.

12. The disk of claim 11, wherein the portion of the surface of the clamping zone is provided with one or more protrusions.

13. The disk of claim 11, wherein the portion of the surface of the clamping zone is provided with one or more recessed portions.

14. The disk of claim 11, wherein the portion of the surface of the clamping zone is provided with one or more ridges.

15. The disk of claim 14, wherein the one or more ridges are provided in a radial direction of the disk.

16. The disk of claim 11, wherein the portion of the surface of the clamping zone is provided with one or more protrusions, recessed portions, ridges, or a combination thereof.
